(19) United States
(12) Patent Application Publication
(10) Pub. No.: US 2019/0205941 A1
(43) Pub. Date: Jul. 4, 2019

(54) POST-PURCHASE USAGE ANALYTICS TO PROMPT RESELLING OF ITEMS IN AN ONLINE MARKETPLACE

(71) Applicant: eBay Inc., San Jose, CA (US)

(72) Inventors: Corinne Elizabeth SHERMAN, San Jose, CA (US); David RAMADGE, San Jose, CA (US); Justin VAN WINKLE, Los Gatos, CA (US); Dane GLASGOW, Los Altos, CA (US)

(73) Assignee: eBay Inc., San Jose, CA (US)

(21) Appl. No.: 14/588,252

(22) Filed: Dec. 31, 2014

(51) Int. Cl. G06Q 30/02

(52) U.S. Cl. CPC G06Q 30/0271

(57) ABSTRACT

A system and method for prompting, soliciting, or otherwise encouraging an owner of an item to resell the item in an online marketplace. A number of post-purchase analytics about the item can inform as to the desirability of presenting the owner with an opportunity to post a listing for the item in the online opportunity. The analytics derive from a variety of information about the item. The information can be compiled using any technique in which the information can be compiled and analyzed.

### BACKGROUND

The present disclosure relates generally to a method and system for prompting reselling of an item in an online marketplace.

Online marketplaces include sellers and potential sellers listing items for sale, and buyers and potential buyers buying the items. For various reasons, depending on the item or some attribute of the item, it may be desirable to solicit a buyer of an item to resell the item in the online marketplace.

### BRIEF DESCRIPTION OF THE DRAWINGS

FIG. 1 is a network diagram depicting a network system having a client-server architecture configured for exchanging data over a network, according to one embodiment.

FIG. 2 is a block diagram illustrating an embodiment of an operation of an attribute analytics system to prompt the sale of an item.

FIG. 3 is a block diagram illustrating an embodiment of the attribute analytics application.

FIG. 4 is a flow diagram illustrating an embodiment of a method for prompting the sale of an item.

FIG. 5 is a block diagram illustrating an embodiment of an operation of an attribute analytics system to send an alert concerning a duplicate or similar item.

FIG. 6 is a block diagram illustrating an embodiment of an attribute analytics application.

FIG. 7 is a flow diagram illustrating an embodiment of a method for sending an alert concerning a duplicate or similar item.

FIG. 8 is a diagrammatic representation of an embodiment of a computer system which may perform one or more of the methods, functions, and/or techniques disclosed herein.

### DETAILED DESCRIPTION

A method, system, and non-transitory computer readable storage medium for prompting the sale of an item are described. An item is identified, along with an attribute of the item. For example, the attribute may be whether the item is infrequently used, sufficiently used, outdated, or sufficiently old, among other things. Depending on the attribute, an alert may be sent to the owner to prompt the owner to resell the item.

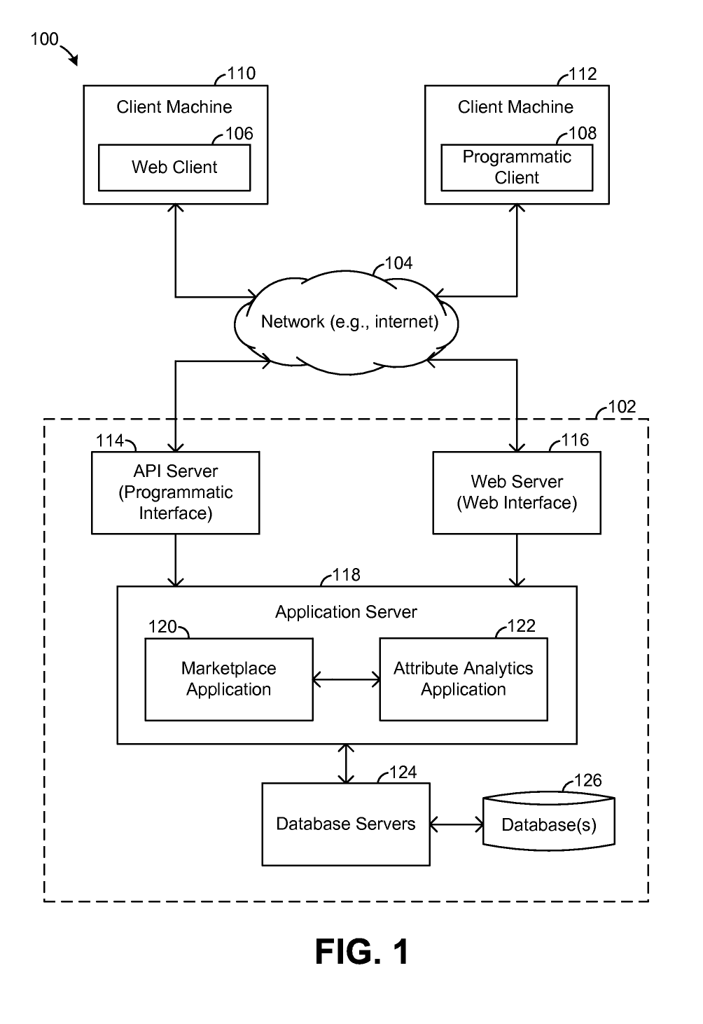

FIG. 1 is a network diagram depicting a network system 100 having a client-server architecture configured for exchanging data over a network, according to an embodiment. The data may pertain to various functions (e.g., online item purchases) and aspects (e.g. managing content) associated with the network system 100 and its users. Although illustrated herein as a client-server architecture, other embodiments may include other network architectures, such as peer-to-peer or distributed network environments.

A data exchange platform, for example, a marketplace application 120, and an attribute analytics application 122, may provide server-side functionality via a network 104 (e.g., the Internet) to one or more clients. The one or more clients may include users that utilize the network system 100 and, more specifically, the marketplace application 120 and the attribute analytics application 122, to exchange data over the network 104. The utilization may include transmitting, receiving (communicating), and processing data to, from and regarding content and users of the network system 100. The data may include, but are not limited to, content data such as item attributes, pricing and descriptive information, item listings associated with buyers and sellers, and auction bids. The data may also include transaction data involving collection and payment, shipping transactions, and real time synchronization of financial journals, among others. In an embodiment, the network system 100 accommodates buying and selling of items in an online marketplace.

In various embodiments, the data exchanges within the network system 100 may depend on user-selection functions available through one or more client or user interfaces (UIs). The UIs may be associated with a client machine, such as a client machine 110 using a web client 106. The web client 106 may communicate with the marketplace application 120 over network 104 via a web server 116. The UIs may also be associated with a client machine 112 using a programmatic client 108 such as a client application. It can be appreciated that in various embodiments, the client machines 110 and 112 may be associated with a buyer or a seller in an online marketplace.

Turning more specifically to the marketplace application 120 and the attribute analytics application 122, an application program interface (API) server 114 and a web server 116 are coupled to, and provide programmatic and web interfaces respectively to, one or more application servers 118. The application server 118 hosts one or more marketplace applications 120 and may host one or more attribute analytics applications 122. The application server 118, in turn, may be coupled to one or more database servers 124 that facilitate access to one or more databases 126.

In an embodiment, the web server 116 and the API server 114 communicate and receive data pertaining to listings, transactions, and item attributes. For example, the web server 116 may send and receive data to and from a webpage on a browser application (e.g., web client 106) operating on a client machine (e.g., client machine 110). The API server 114 may send and receive data to and from an application (e.g., programmatic client 108) running on another client machine (e.g., client machine 112).

In an embodiment, the marketplace application 120 facilitates listings and price-setting for sellers and buyers to list, bid on, and/or buy items in the online marketplace.

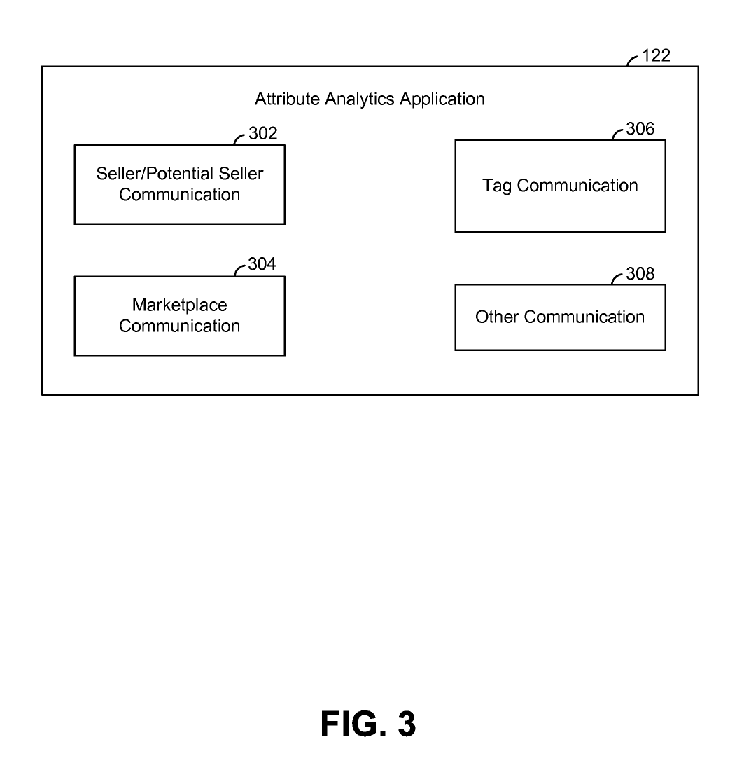

In an embodiment, the attribute analytics application 122 includes a method and computer readable storage medium for prompting the sale of an item. The attribute analytics application 122 is described in more detail below with reference to FIG. 3.

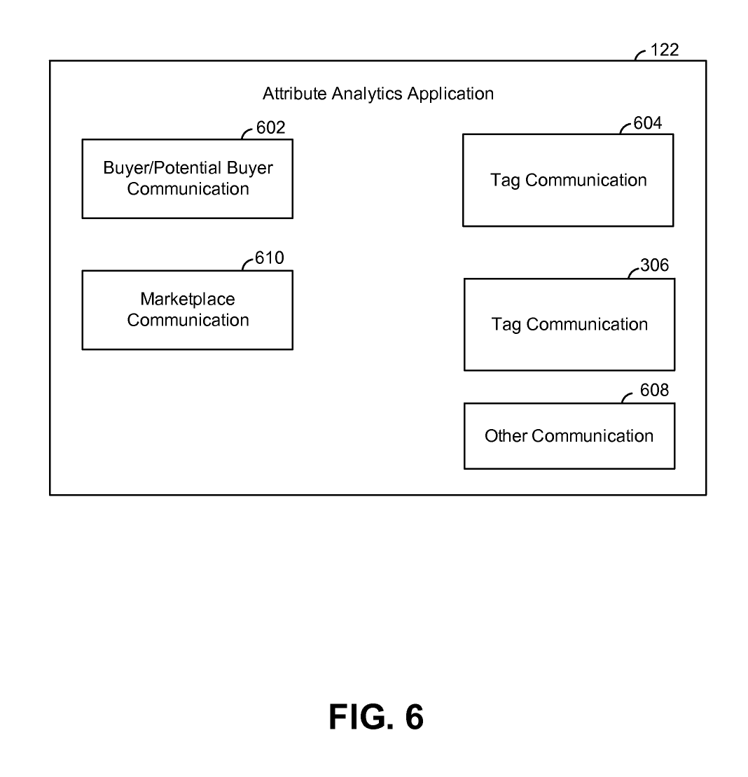

In one embodiment, the attribute analytics application 122 includes a system for sending an alert concerning a duplicate or similar item. The attribute analytics application 122 is described in more detail below with reference to FIG. 6.

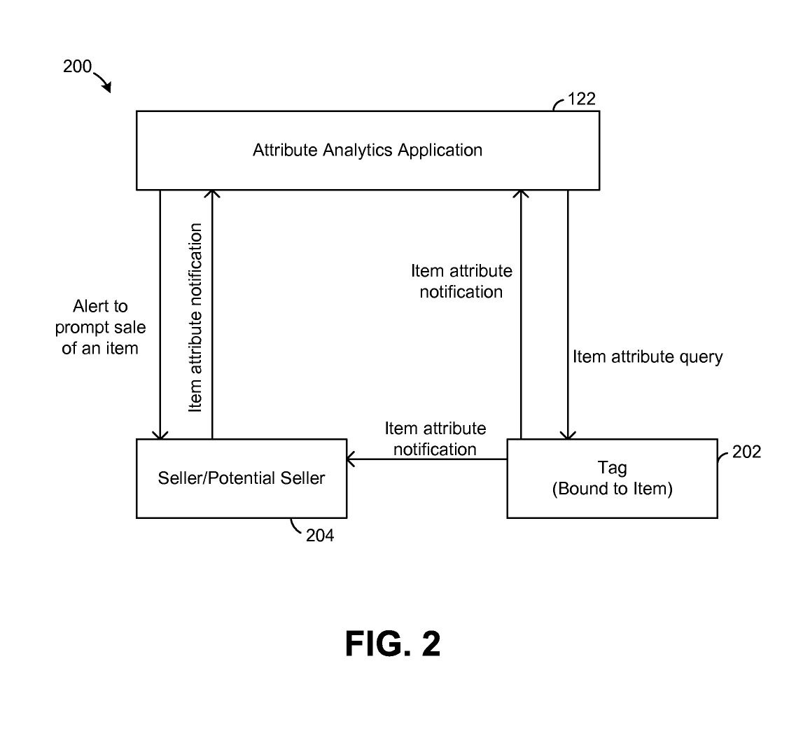

FIG. 2 is a block diagram illustrating an embodiment of an operation of an attribute analytics system 200 to prompt the sale of an item. Tag 202 is bound to an item bought or acquired by the seller/potential seller 204. The seller/potential seller 204 may attach tag 202 to the item, or tag 202 may have been attached to the item when seller/potential seller 204 bought or acquired the item.

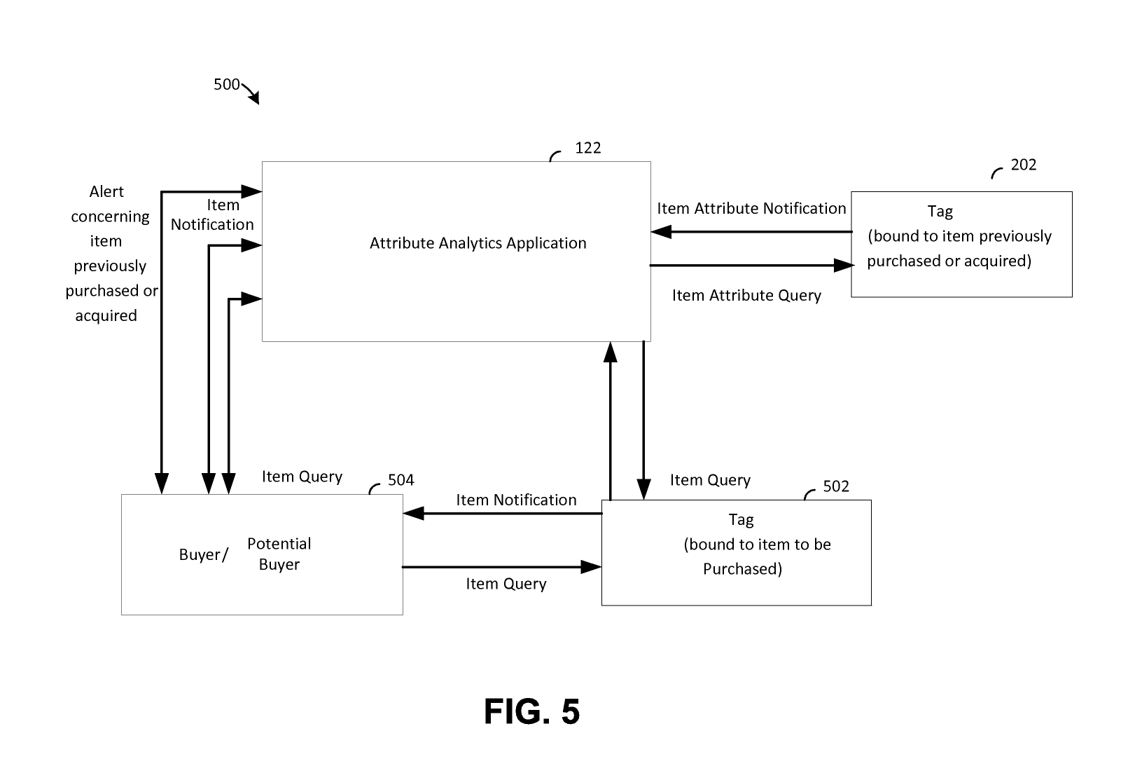

It should be noted that, while much of the following discussion, as well as discussion pertaining to FIG. 5, is going to relate to the use of tags to identify items that may be bought and sold in an online marketplace, there are many other potential sources of data about such items. Any number of data gathering devices and systems, available in home, work, or other environments, may provide information about the items. By way of non-limiting example, a potential reseller of an item may have video cameras or other data acquisition devices located throughout the reseller's residence or place of business. Those cameras or other data acquisition devices can be used to acquire data about an item's usage, frequency of usage, condition, and the like. The use of various kinds of tags as described herein can be useful in environments and circumstances in which video information is not readily available (e.g. unavailing in a dark closet), or is insufficiently informative (e.g. non-visual information). Various kinds of sensors and information-gathering and providing mechanisms may provide relevant information to warrant soliciting an owner of an item to sell or resell it.

Going back to the embodiment(s) of FIG. 2, tag 202 can be, for example, a radio frequency identification (RFID) tag, a bar code, a magnetic tag or a polymer tag, or any tag employing available item-level tagging technology.

Tag 202 may be passive (containing no internal power source for communications and data transmission) or active. Further, tag 202 may or may not have processing capacity. Tag 202 may include an electronic chip with dynamic data storage and external read/write abilities.

In this specification, tag 202 should be understood to be a tag with unique identifying information (digital, analog, or having other physical characteristics) that can be read directly from the tag, in some cases using some kind of reader. The reader can be optical, magnetic, opto-magnetic, or other technology that can interpret the appropriate physical characteristics of the tag. The reader can read tag 202 either with or without physical contact between the tag and the reader.

Further, tag 202 may include various sensors to determine when an item is used or relocated. For example, the tag may include sensors that measure the item's temperature, movement, vibration, orientation, smell, molecular composition, and exposure to moisture and other substances. The item's movement may be tracked by a global positioning satellite (GPS) receiver in association with a conventional communication system, such as a cell phone or a low-band-width satellite uplink system. Alternatively, the item's location may be tracked with Real Time Location Systems (RTLS) or other technologies.

The item to which tag 202 is attached may be an electronic device such a tablet, cell phone, laptop, or MP3 player. Alternatively, the item could be an article of clothing, an antique, jewelry or a toy. The item can be any physical object the seller/potential seller 204 has purchased or acquired. Further, seller/potential seller 204 may have purchased the item online (e.g., from an online marketplace). Alternatively, the item may have been purchased from a brick-and-mortar store or other location.

The item also has at least one attribute which is determined by tag 202. Among the attributes may be an indication of whether an item is currently being used. The attribute may be an indication of whether the item has been used in the past, and if so, when. This kind of attribute may reflect a usage profile. Alternatively or additionally, the attribute can be the frequency with which the item is used. The attribute can also include at least one threshold frequency that can be determined from a usage profile or a source external to the item. For example, a threshold frequency can be a frequency indicating that the item is infrequently used or that the item is sufficiently used. As another example, the attribute may indicate the age of the item. The age may be measured from the time the item is manufactured, sold, purchased, or another time. Further, the attribute may represent the item's version or model number. For example, if the item is a smartphone, one attribute may indicate the device brand, another might indicate the version, and yet another might indicate the model number. The version or model number may provide useful information about the age of the item.

Certain attributes may be determined in the attribute analytics application 122. For example, if tag 202 sends an item attribute notification to the attribute analytics application 122 each time the item bound to tag 202 is used (e.g. when the item is moved, as might be the case when a wearer dons a tagged article of clothing, or a golfer goes out with a tagged golf bag), application 122 can calculate the frequency with which the item is used. For example a sweater may sit in a drawer, or a golf bag may sit in a closet, for long periods of time without being used. Sitting longer than a particular period of time (e.g. a season, or a year) may indicate non-use, and hence a potential listing or sale. Attribute analytics application 122 can also receive information from other sources to verify attributes of the item. For example, application 122 may receive information, such as an item's location, from some device where the item is located, such as a home computer. This information can be used to verify the location information sent from tag 202 to application 122. Alternatively, application 122 can receive information about the item's circumstances or environment from other sources. For example, if the item is located outside, and if application 122 receives weather information indicating that it is raining where the item is located, this information can be used to verify information sent from tag 202 concerning the item's contact with moisture, and thus, potentially, the item's condition.

Once the seller/potential seller 204 has bought or acquired the item, and once tag 202 is bound to the item, tag 202 may send an item attribute notification to the attribute analytics application 122. The item attribute notification may indicate any or all of the item's attributes that sensors on the tag, or information stored in the tag can provide. Tag 202 may also send the item attribute notification after receiving an item attribute query from the attribute analytics application 122. The item attribute query may be a request that tag 202 send the attribute analytics application 122 at least one attribute of the item.

Alternatively, tag 202 may send an item attribute notification to seller/potential seller 204. After seller/potential seller 204 receives the item attribute notification, it may send the notification to the attribute analytics application 122.

If the attribute analytics application 122 determines that the item bound to tag 202 is infrequently used, sufficiently used, of a certain age, outdated, or otherwise displays a characteristic indicating that it possibly is not needed by seller/potential seller 204 any more, attribute analytics application 122 can send an alert to seller/potential seller 204 to solicit the listing of the item on an online marketplace. The alert may include the name of the item, the attribute(s) that triggered the alert, and a pre-populated form that can be used to list the item for sale on the online marketplace. For example, the form may contain the name or unique identification of the item, a photo of the item, and a suggested sale price. In an embodiment, the form also may contain, and the name/ID and/or possible contact information of the seller/potential seller 204.

Further, the alert may be in any form for transmission, such as a message over a communications medium that the online marketplace provides. The alert may be an email, text message, tweet or other social media-sourced message, pager message, phone call, fax, or letter. Similarly, the item attribute notifications and item attribute queries sent between tag 202, seller/potential seller 204 and attribute analytics application 122 may be in any form of transmission.

Further, attribute analytics application 122 may be hosted in any suitable computing device. For example, the application can reside in application server 118, client machine 110 or client machine 112.

FIG. 3 is a block diagram illustrating an embodiment of the attribute analytics application 122. The attribute analytics application 122 may include a seller/potential seller communication module 302, marketplace communication module 304, tag communication module 306, and other communication module 308. Each module within the attributes analytics application 122 may send and receive information in any form of transmission.

The seller/potential seller communication module 302 communicates information with seller/potential seller 204. For example, module 302 from seller/potential seller 204. Further, the seller/potential seller communication module 302 may send and receive information in any form of transmission. For example, module 302 may communicate through technologies such as HTML or XML-based, voice controlled, stylus controlled and multi-modal human interfaces including all kinds of data visualization technologies. The seller/potential seller communication module 302 may also receive an item attribute query and forward the query to tag 202. Further, seller/potential seller communication module 302 may also receive an alert to prompt the sale of the item bound to tag 202.

The marketplace communication module 304 communicates information with seller/potential seller 204 and tag 202. The marketplace communication module may also communicate with API server 114, web server 116, application server 118, database servers 124 and database(s) 126.

The tag communication module 306 communicates information with tag 202. For example, module 306 may receive an item attribute notification from tag 202. Tag communication module 306 may also send this notification in response to an item attribute query. Similarly, tag communication module 306 communicates information from tag 202 to the seller/potential seller 204. For example, module 306 may send an item attribute notification from tag 202 to seller/potential seller 204. Tag communication module 306 may also send this notification after receiving an item attribute query from seller/potential seller 204.

The other communication module 308 may communicate information to and from tag 202, seller/potential seller 204, and other entities. Alternatively, any other communication module in FIG. 3 could perform module 308's communication function. In fact, any of the communications modules shown in FIG. 3 may perform any of the necessary communications functions for attribute analytics application 122, as desired.

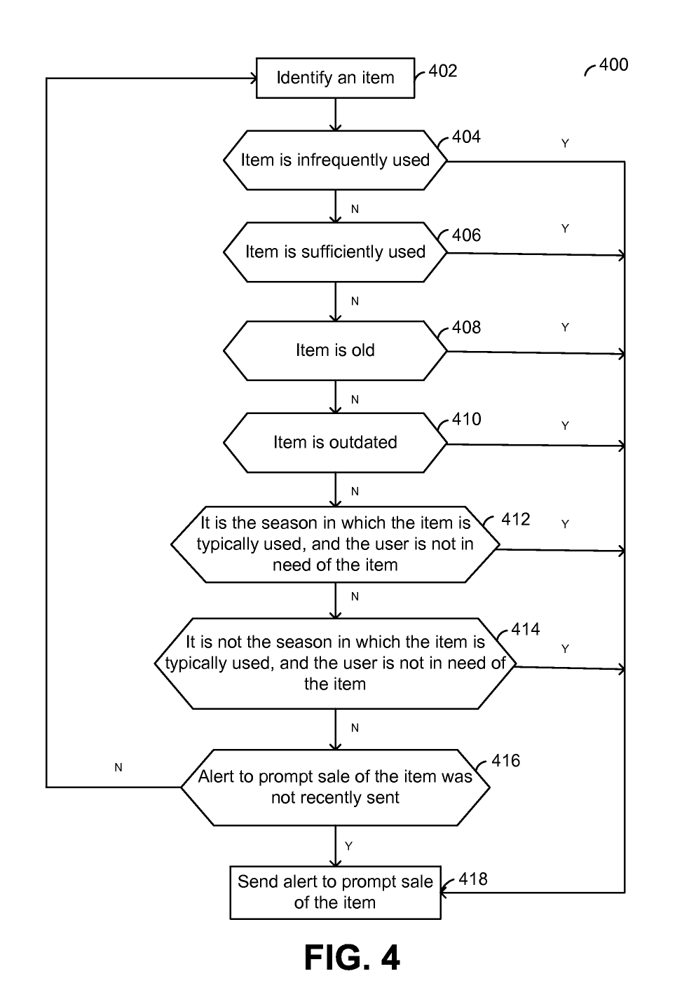

FIG. 4 is a flow diagram illustrating an embodiment of a method 400 for prompting the sale of an item. The method 400 includes various operations. At operation 402, an item, which is bound to tag 202, is identified. As discussed previously, the tat 202 will contain various information about attributes of the item. Alternatively, item attribute information can be provided from any information source.

At 404-414, various decisions are taken concerning certain attributes of the item. The sequence in which the decisions are taken does not matter. Likewise, it is not necessary that the flow pass through all of the decision points. At any point in 404-414, if the tag information has indicated that the item has the necessary attribute, flow can skip to any appropriate subsequent decision point, for example, 416 or, as depected, 418.

At 404, the attribute analytics application 122 determines whether the item is infrequently used. As noted above, whether the item is infrequently used can be determined based on at least one threshold usage frequency that is determined from a usage profile, or source external to the item.

At 406, the attribute analytics application 122 determines whether the item is sufficiently used. Like operation 404, this can be determined based on at least one threshold frequency that is determined from a usage profile, or source external to the item.

At 408, the attribute analytics application 122 determines whether the item is sufficiently old. This determination can be based on the age of the item and at least one threshold age. The age of the item may be measured from the time the item is manufactured, sold, purchased, or any other appropriate time. A threshold age may be determined from the item's name or identity, or from database(s) 126. For example, if the item is a laptop, a threshold age for the laptop (the age when the laptop is old), may be one year. Alternatively, it may be two or three years, or more or less as desired. If the age of the item is measured from the time the seller/potential seller 204 purchased or acquired the laptop, and if this age is three years, the age of the item is equal to the threshold age. As a result, the item may be determined to be sufficiently old.

At 410, the attribute analytics application 122 determines whether the item is outdated. This determination can be based on information provided to the attribute analytics application 122 from an external source, such as database(s) 126. The determination may be based on a version or model number of the item, and of an identical or similar item with a more current version or model number. For example, if the item is a smartphone, one attribute may indicate the device brand, another might indicate the version, and yet another might indicate the model number. The version or model number may provide useful information about the age of the item. Further, from an external source, the attribute analytics application 122 may identify a more current version of the smartphone. The smartphone may be one generation old, two generations old, or more. As a result, the attribute analytics application 122 may determine whether the smartphone is outdated.

At 412, the attribute analytics application 122 determines whether it is presently the season in which the item is typically used, and whether the seller/potential seller 204 is not using the item. Such determination may be based on the present date and season, and the season in which the item is typically used in that region. For example, in the upper Midwest region of the United States, golf clubs will be used during a particular time of year. If a couple of golf seasons go by without the clubs being used, the owner may no longer be using the clubs, and may be willing to sell them. This information may be provided by database(s) 126 or other sources. Further, the determination may be based on the seller/potential seller's 204 usage profile of the item. Alternatively, the determination may be based on other information provided by the seller/potential seller 204 or other sources.

At 414, the attribute analytics application 122 determines whether it is presently not the season in which the item is typically used, and whether the user is not in need of the item. Such determination may be based on the present date and season, and the season in which the item is typically used. Information such as that used in 412 may be helpful. For example, if there are three consecutive periods of nonuse and the middle period is a season in which the item normally is not used, there may have been a specific passage of time sufficient to indicate that the owner no longer needs the item. This information may be provided by database(s) 126 or other sources. Further, the determination may be based on the seller/potential seller's 204 usage profile of the item. Alternatively, the determination may be based on other information provided by the seller/potential seller 204 or other sources.

At 416, the attribute analytics application 122 determines whether an alert to prompt a sale of the item was not recently sent. This determination is based on a threshold period that is measured from the time an alert to prompt a sale of the item was previously sent. The threshold period may be provided from the source of the previous alert, such as some part of the online marketplace itself, or another external source. For example, if the threshold period is 60 days, and more than 60 days have passed since the attribute analytics application 122 last sent an alert to prompt sale of the item, application 122 may determine that an alert was not recently sent. In an embodiment, application 122 may determine that seller/potential seller 204 has not elected to sell the item, even after receiving a number of alerts previously. Seller/potential seller 204 may even have responded with a request not to receive any such further alerts. As a result, application 122 may decide not to send any subsequent alerts because seller/potential seller 204 has confirmed his/her wish not to sell the item. For a particular item for which an owner has signified an intention not to sell, the decisions and actions in FIG. 4 may not occur.

At operation 418, the attribute analytics application 122 sends an alert to the seller/potential seller 204 to prompt a sale of the item. As noted above, the alert may include a pre-populated form that can be used to list the item for sale on an online marketplace.

In one embodiment, the attribute analytics application 122 determines whether the seller/potential seller 204 is physically separated from the item and in need of the item. This determination may be based on the relative location of tag 202 and the seller/potential seller 204. The determination may be further based on additional information provided by seller/potential seller 204 or other sources indicating that the seller/potential seller 204 is in need of the item. Upon making this determination, application 122 sends seller/potential seller 204 an alert prompting seller/potential seller 204 to purchase an identical or similar item.

FIG. 5 is a block diagram illustrating an embodiment of an operation of an attribute analytics system to send an alert concerning a duplicate or similar item. Tag 502 is bound to an item that buyer/potential buyer 504 is about to purchase.

Tag 502 can have any or all of the characteristics of tag 202; may be attached to any item to which tag 202 can be attached; and may identify any attribute of the item that tag 202 can identify, per the foregoing description.

Before buyer/potential buyer 504 has bought or acquired the item, tag 504 may send an item attribute notification to the attribute analytics application 122. The item attribute notification may indicate any or all of the item's attributes. Tag 502 may also send the item attribute notification after receiving an item attribute query from the attribute analytics application 122. The item attribute query may be a request that tag 502 send the attribute analytics application at least one attribute of the item.

Alternatively, tag 502 may send an item attribute notification to buyer/potential buyer 504. Tag 502 may send this notification after receiving an item attribute query from the buyer/potential buyer 504.

After buyer/potential buyer 504 receives an item attribute notification, it may send the notification to the attribute analytics application 122. The buyer/potential buyer 504 may send this notification after receiving an item attribute query from the attribute analytics application 122.

The attribute analytics application 122 may also send an item attribute query to tag 202, which is bound to an item that buyer/potential buyer 504 previously purchased or acquired. Tag 202 may send an item attribute notification to the attribute analytics application 122. Alternatively, attribute analytics application 122 may send an item attribute query to another entity that stores information about tag 202, or that communicates with tag 202. Such an entity may be a home computer, for example. Further, attribute analytics application 122 may receive an item attribute notification from an entity that stores information about tag 202, or that communicates with tag 202.

If the attribute analytics application 122 determines that the item bound to tag 502 is identical or sufficiently similar to the item bound to tag 202, application 122 can send an alert to buyer/potential buyer 504. The alert may indicate that buyer/potential buyer has already purchased an item identical or similar to the item bound to tag 502. The alert may also indicate other attributes of the item bound to tag 202.

The alert may be in any form of transmission, as described earlier. Similarly, the item attribute notifications and item attribute queries sent among tag 502, buyer/potential buyer 504, attribute analytics application 122, tag 202, and other entities may be in any form of transmission.

As noted above, attribute analytics application 122 may be hosted in any computing device. For example, the application can reside in application server 118, client machine 110 or client machine 112.

FIG. 6 is a block diagram illustrating an embodiment of an attribute analytics application 122. The attribute analytics application 122 may include a buyer/potential buyer communication module 602, marketplace communication module 610, tag communication module 306, tag communication module 604, and other communication module 608. Each module within the attributes analytics application 122 may send and receive information in any form of transmission.

The buyer/potential buyer communication module 602 communicates information with tag 502. For example, module 602 may receive an item attribute notification from tag 502. As noted above, the buyer/potential buyer communication module 602 may send and receive information in any form of transmission. The buyer/potential buyer communication module 602 may also receive an item attribute query and forward the query to tag 502. Further, buyer/potential buyer communication module 602 may also receive an alert concerning buyer/potential buyer's 504 previous acquisition or purchase of the item bound to tag 202.

The marketplace communication module 610 communicates information to and from buyer/potential buyer 504, tag 502, tag 202, and any other entities that store information about or that communicate with tag 202. The marketplace communication module may also communicate with API server 114, web server 116, application server 118, database servers 124 and database(s) 126.

The tag communication module 604 communicates information with tag 502. For example, module 604 may send an item attribute notification from tag 502. Tag communication module 604 may also send this notification after receiving an item attribute query. Similarly, tag communication module 604 communicates information from tag 502 to the buyer/potential buyer 504. For example, module 604 may send an item attribute notification from tag 502 to buyer/potential buyer 504. Tag communication module 604 may also send this notification after receiving an item attribute query from buyer/potential buyer 504.

The tag communication module 306 communicates information with tag 202. For example, module 306 may send an item attribute notification from tag 202. Tag communication module 306 may also send this notification after receiving an item attribute query.

The other communication module 608 may communicate information to and from tag 502, buyer/potential buyer 504, attribute analytics 122, tag 202, and other entities.

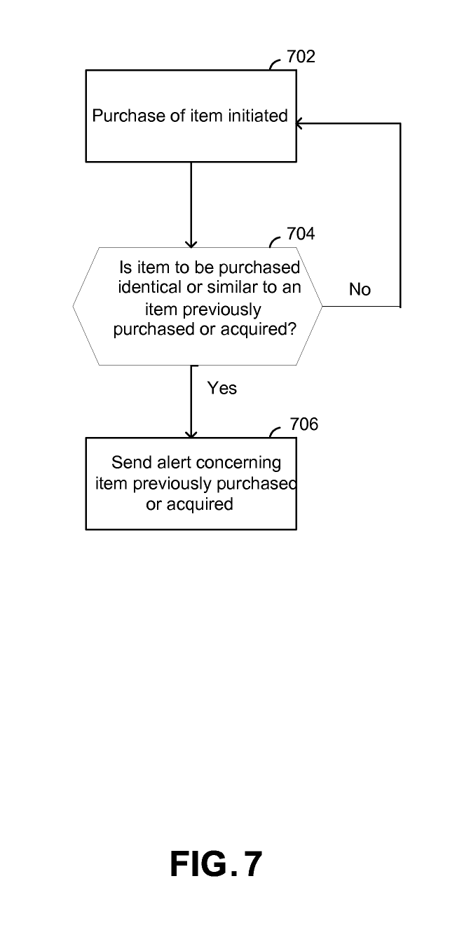

FIG. 7 is a flow diagram illustrating an embodiment of a method 700 for sending an alert concerning a duplicate or similar item. At 702, buyer/potential buyer 504 initiates the purchase of an item bound to tag 502. At 704, attribute analytics application 122 determines whether the item bound to tag 502 (the item to be purchased) is identical or similar to an item bound to tag 202, which buyer/potential buyer 504 previously purchased or acquired. If the item bound to tag 604 is not identical or similar to the item bound to tag 202, the process starts over. If the item bound to tag 604 is identical or similar to the item bound to tag 202, at 706 the attribute analytics application 122 sends an alert to buyer/potential buyer 504 concerning the identical or similar item bound to tag 202.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of the exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. In some embodiments, the modules referred to herein may be processor-implemented.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network 104 (e.g., the Internet) and via one or more appropriate interfaces (e.g., APIs).

### Electronic Apparatus and System

Embodiments may be implemented in digital electronic circuitry, or in computer hardware, firmware, software, or in combinations thereof. Embodiments may be implemented using a non-transitory computer-readable storage medium, (e.g., a computer program tangibly embodied in an information carrier, e.g., in a non-transitory machine-readable medium for execution by, or to control the operation of, data processing apparatus, e.g., a programmable processor, a computer, or multiple computers).

A computer program can be written in any form of programming language, including compiled or interpreted languages, and can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network 104.

In embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network such as network 104. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware, may be a design choice. Hardware (e.g., machine) and software architectures that may be deployed in various embodiments now will be described.

### Example Computer System

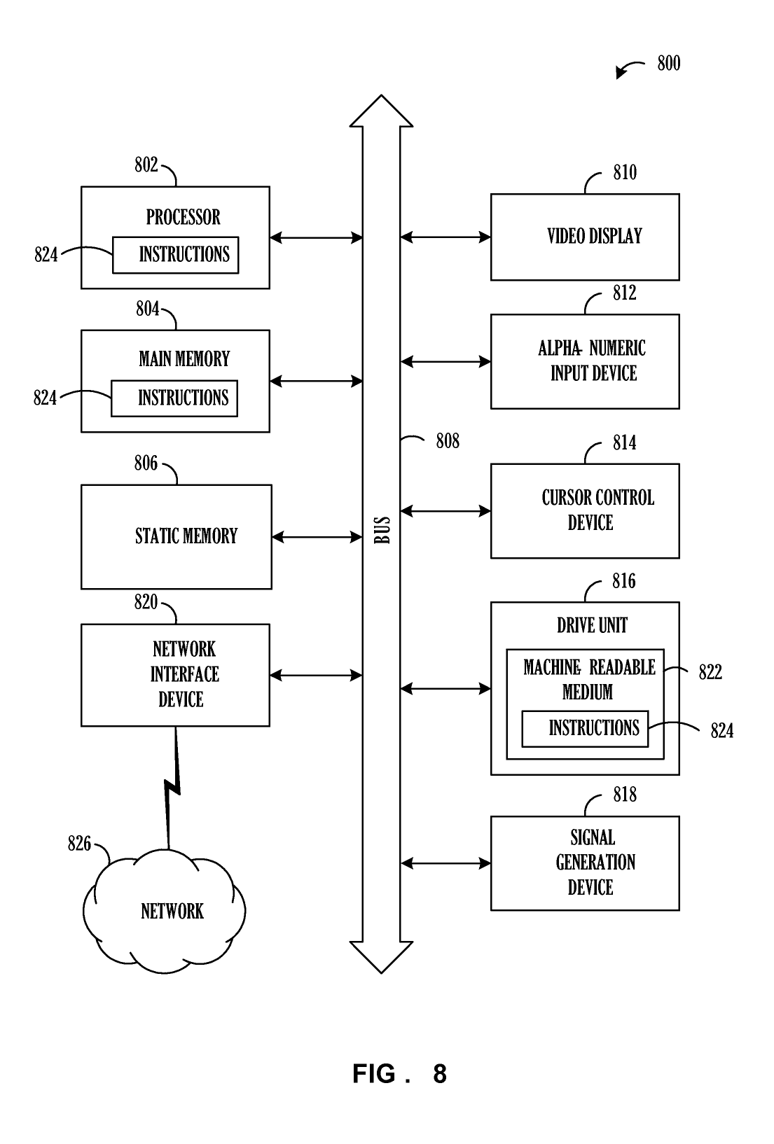

FIG. 8 is a diagrammatic representation of an exemplary computer system 800, within which a set of instructions may be executed to cause the machine to perform any one or more of the methodologies discussed herein. The computer system 800, in whole or in part, may be embodied in any of the servers or other machines shown in FIG. 1.

In some embodiments, the machine operates as a standalone device, or may be connected (e.g., networked) to other machines. In a networked deployment, the machine may operate as a server or a client machine 110 or 112 in a client-server network environment, or as a peer machine in a peer-to-peer (or distributed) network environment. The machine may be a personal computer (PC), a tablet, a set-top box (STB), a personal digital assistant (PDA), a smartphone, a web appliance, a network router, switch or bridge, or any machine capable of executing a set of instructions 824 (sequential or otherwise) that specify actions to be taken by that machine. Further, while only a single machine is illustrated, the term “machine” shall also be taken to include any collection of machines that individually or jointly execute a set (or multiple sets) of instructions 824 to perform any one or more of the methodologies discussed herein.

In an embodiment, the computer system 800 may include a processor 802 (e.g., a central processing unit (CPU), a graphics processing unit (GPU, or both)), a main memory 804 and a static memory 806, which communicate with each other via a bus 808. The computer system 800 may further include a video display unit 810 (e.g., a liquid crystal display (LCD), a plasma display, a light-emitting diode (LED) display, or a cathode ray tube (CRT) display). The computer system 800 also may include an alphanumeric input device 812 (e.g., a keyboard or keypad), a UI navigation device 814 (e.g., a mouse or touchpad), a disk drive or other storage (e.g. solid-state device, or SSD) unit 816, a signal generation device 818 (e.g., a speaker), and a network interface device 820.

The disk drive unit 816 may include a machine-readable medium 822 on which is stored one or more sets of instructions and data structures (e.g., software 824) embodying or utilized by any one or more of the methodologies or functions described herein. The instructions 824 may also reside, completely or at least partially, within the main memory 804 and/or within the processor 802 during execution thereof by the computer system 800, with the main memory 804 and the processor 802 also constituting machine-readable media 822.

The instructions 824 may further be transmitted or received over a network 826 (which is not part of the computer system 800) via the network interface device 820, utilizing any one of a number of well-known transfer protocols (e.g., HTTP).

While the machine-readable medium 822 is shown in an embodiment to be a single medium, the term “machine-readable medium” should be taken to include a single medium or multiple media (e.g., a centralized or distributed database, and/or associated caches and servers) that store the one or more sets of instructions 824. The term “machine-readable medium” shall also be taken to include any medium that is capable of storing, encoding, or carrying a set of instructions 824 for execution by the machine and that cause the machine to perform any one or more of the methodologies of the present disclosure, or that is capable of storing, encoding or carrying data structures utilized by or associated with such a set of instructions 824. The term “machine-readable medium” shall, accordingly, be taken to include, but not be limited to, solid-state memories, optical media, and magnetic media.

As alluded to earlier, particular sequences of operations in various embodiments are provided for convenience, and are not intended to imply that the same order is required in all embodiments. Any operational sequence in which a subsequent operation does not depend on a previous one is appropriately within the scope of this disclosure.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that, in some cases, various features may be grouped together to streamline the disclosure. This method of disclosure is not to be interpreted as reflecting an intention that the claimed embodiments require more features than are expressly recited in each claim. Rather, the following claims reflect subject matter including fewer than all features of a single disclosed embodiment. Thus, the following claims are hereby incorporated into the Detailed Description, with each claim standing on its own as a separate embodiment.

Although the present disclosure has been described with reference to certain embodiments, it will be evident that various modifications and changes may be made to these embodiments without departing from the broader spirit and scope of the disclosure. Accordingly, the specification and drawings are to be regarded in an illustrative rather than a restrictive sense.

1-20. (canceled)

21. A computer implemented method to obtain device attributes, the method comprising:
obtaining, by an application server, first electronic communications based on wireless communications from a tag associated with a physical object, the first electronic communications including usage information collected by the tag regarding usage of the physical object;
further obtaining, by the application server, second electronic communications based on the wireless communications from the tag, the second electronic communications including information related to a device attribute of the physical object and the device attribute including a version of the physical object or model number of the physical object;
receiving, by the application server, additional information from an external source, the additional information being used to verify information sent from the tag or to verify an environmental condition of the physical object;
determining, by the application server, a usage pattern of the physical object based on the usage information from the first electronic communications, the device attribute of the physical object, and the received additional information;
comparing, by the application server, the usage pattern to a plurality of usage criteria;
in response to the usage pattern meeting at least one of the plurality of usage criteria, automatically generating, by the application server, an electronic message that solicits an owner of the physical object to list the physical object for sale on an online marketplace hosted on an online marketplace server, the electronic message including a pre-populated form with information about the physical object for listing the physical object for sale on the online marketplace that includes a graphic of the physical object, written information about the physical object, and a suggested sale price for the physical object;
transmitting the electronic message to a device associated with the owner of the physical object; and
listing, by the application server, the physical object as an item for sale on the online marketplace server, the item for sale on the online marketplace server being based on the pre-populated form.

22. The computer implemented method of claim 21, wherein the plurality of usage criteria is selected from a group consisting of:
sufficient use of the physical object;
sufficient age of the physical object;
change in movement of the physical object; and
change in orientation of the physical object.

23. The computer implemented method of claim 21, wherein the usage information is selected from a group consisting of:
frequency of use of the physical object;
duration of use of the physical object;
age of the physical object;
temperature of the physical object;
movement of the physical object;
location of the physical object;
vibration of the physical object; and
orientation of the physical object.

24. (canceled)

25. The computer implemented method of claim 21, wherein the first electronic communications are transmitted by a second computing system that receives the wireless communications from the tag.

26-27. (canceled)

28. A non-transitory computer readable media configured to store a set of instructions that, when executed by one or more processors, cause a system to perform operations comprising:
obtain first electronic communications based on wireless communications from a tag associated with a physical object, the first electronic communications including usage information collected by the tag regarding usage of the physical object;
further obtain, second electronic communications based on the wireless communications from the tag, the second electronic communications including information related to a device attribute of the physical object and the device attribute including a version of the physical object or model number of the physical object;
receive additional information from an external source, the additional information being used to verify information sent from the tag or to verify an environmental condition of the physical object;
determine a usage pattern of the physical object based on the usage information from the first electronic communications, the device attribute of the physical object, and the received additional information;
compare the usage pattern to a plurality of usage criteria;
in response to the usage pattern meeting at least one of the plurality of usage criteria, automatically generate an electronic message that solicits an owner of the physical object to list the physical object for sale on an online marketplace hosted on an online marketplace server, the electronic message including a pre-populated form with information about the physical object for listing the physical object for sale on the online marketplace that includes a graphic of the physical object, written information about the physical object, and a suggested sale price for the physical object;
transmit the electronic message to a device associated with the owner of the physical object; and
list the physical object as an item for sale on the online marketplace server, the item for sale on the online marketplace server being based on the pre-populated form.

29. The non-transitory computer readable media of claim 28, wherein the plurality of usage criteria is selected from a group consisting of:
sufficient use of the physical object;
sufficient age of the physical object;
change in movement of the physical object; and
change in orientation of the physical object.

30. The non-transitory computer readable media of claim 28, wherein the usage information is selected from a group consisting of:
frequency of use of the physical object;
duration of use of the physical object;
age of the physical object;
temperature of the physical object;
movement of the physical object;
location of the physical object;
vibration of the physical object; and
orientation of the physical object.

31. (canceled)

32. The non-transitory computer readable media of claim 28, wherein the first electronic communications are transmitted by a second computing system that receives the wireless communications from the tag.

33-34. (canceled)

35. A computer implemented method to obtain device attributes, the method comprising:
obtaining a first electronic communication based on a first wireless communication from a first tag associated with a first physical object, the first electronic communication including first information collected by the first tag regarding aspects of the first physical object;
obtaining a second electronic communication based on a second wireless communication from a second tag associated with a second physical object, the second electronic communication including second information collected by the second tag regarding aspects of the second physical object;
comparing, using a computing system, the first information and the second information;
in response to the first information and the second information being associated, automatically generating, using the computing system, an electronic message regarding the association between the first physical object and the second physical object; and
transmitting the electronic message to a device associated with an owner of the first physical object.

36. The computer implemented method of claim 35, wherein the aspects of the first physical object include a make, a model, and/or a year of the first physical object and the aspects of the second physical object include a make, a model, and/or a year of the second physical object.

37. The computer implemented method of claim 35, further comprising transmitting a third electronic communication to the first tag, the third electronic communication received by the first tag over a wireless network, wherein in response to the third electronic communication, the first tag wirelessly transmits the first information collected by the first tag.

38. The computer implemented method of claim 35, further comprising transmitting a third electronic communication to the second tag, the third electronic communication received by the second tag over a wireless network, wherein in response to the third electronic communication, the second tag wirelessly transmits the second information collected by the second tag.

39. The computer implemented method of claim 35, wherein the second electronic communication is transmitted by the device associated with the owner of the first physical object, wherein the device receives the second wireless communication from the second tag.

40. The computer implemented method of claim 39, wherein the second wireless communication is transmitted by the second tag in response to a third wireless communication received by the second tag from the device associated with the owner of the first physical object.
